(19) United States
(12) Patent Application Publication
(10) Pub. No.: US 2016/0318595 A1
(43) Pub. Date: Nov. 3, 2016

(54) ASSEMBLING OF STRUCTURAL ELEMENTS IN AVIATION

(71) Applicant: Airbus Operations GmbH, Hamburg (DE)

(72) Inventor: Dimitri ORLOV, Tornesch (DE)

(21) Appl. No.: 15/142,251

(22) Filed: Apr. 29, 2016

(30) Foreign Application Priority Data
Apr. 30, 2015 (DE) 102015106761.7

(51) Int. Cl. B64C 1/12

(52) U.S. Cl. CPC B64C 1/12

(57) ABSTRACT

This pertains to an aircraft structure with a first shell-shaped structural element and a second shell-shaped structural element. The aircraft structure comprises a strap, wherein the first shell-shaped structural element and the second shell-shaped structural element are respectively fastened on the strap by means of a rivet joint. An edge of the first shell-shaped structural element extends on a surface of the strap along a predefined curve with periodic progression. An edge of the second shell-shaped structural element likewise extends on the surface of the strap parallel to the curve with periodic progression. The invention furthermore pertains to an aircraft with an aircraft structure, as well as a method for manufacturing an aircraft structure.

### CROSS-REFERENCE TO RELATED APPLICATION

This application claims priority to German Patent Application No. 102015106761, filed Apr. 30, 2015, which is incorporated herein by reference in its entirety.

### TECHNICAL FIELD

The embodiments described herein realte to the assembly of structural elements in aviation, particularly to an aircraft structure, an aircraft with an aircraft structure, as well as a method for manufacturing an aircraft structure.

### BACKGROUND

In addition, other objects, desirable features and characteristics will become apparent from the subsequent summary and detailed description, and the appended claims, taken in conjunction with the accompanying drawings and this background.

Aircraft structures are nowadays manufactured with different methods. For example, structural components or structural elements of an aircraft structure are manufactured by means of different joining processes. Welded joints, soldered joints or adhesive joints, in particular, may be considered for this purpose. Furthermore, the structural elements of an aircraft structure can also be fastened on one another by means of screw joints or rivet joints. In this case, the locations, at which the structural elements of the aircraft structure are connected to one another or fastened on one another, are subjected to different loads such as, for example, the tensile loads, pressure loads or torsional loads. In order to transmit these loads as effectively as possible in the region of the joints or connecting points between the structural elements, it is possible to provide joints, the design of which is specifically adapted to the type of load, as well as fastening means that are specifically adapted to the type of load.

DE 10 2010 031 688 A1 describes a lining shell carrying a main load, as well as a structural component and a flow body with such a lining shell carrying a main load. The lining shell is realized with an outer edge section that has an outer edge in order to attach the lining shell to a carrier component. A connecting region without core layer, which comprises an inner skin section and an outer skin section, extends along the edge.

DE 10 2006 060 360 A1 describes a fuselage section for forming a fuselage cell of an aircraft that is constructed sectionally. In this case, the fuselage section may be composed of at least two shells that are continuously welded along longitudinal seams.

### SUMMARY

It is an object of an embodiment to improve a load transmission between structural elements of an aircraft structure.

According to an aspect of the embodiment, an aircraft structure with a first shell-shaped structural element and a second shell-shaped structural element is proposed. The aircraft structure furthermore comprises a strap. In this case, the first shell-shaped structural element and the second shell-shaped structural element are respectively fastened on the strap by means of a rivet joint. An edge of the first shell-shaped structural element extends on a surface of the strap along a predefined curve with periodic progression. For example, the periodic progression is an undulating progression. Furthermore, an edge of the second shell-shaped structural element extends on the surface of the strap parallel to the predefined curve with periodic or undulating progression.

Such an aircraft structure makes it possible to prevent a deflection of the structural elements under external loads. This is particularly important on skin segments of the aircraft because a smooth, aerodynamic contour of the skin leads to little aerodynamic drag. In other words, improved aerodynamic properties can be achieved with the inventive aircraft structure and therefore with the connection of the structural elements, which consist, for example, of structural skin elements, by means of the strap. Furthermore, an improvement of the mechanical properties, particularly the fatigue properties, can be achieved. This ultimately makes it possible to reduce the number of fastening means such as, for example, rivet joints and therefore can also result in weight savings. Another advantage can be seen in that the structural elements, as well as the strap and the fastening means, can have smaller dimensions such that additional weight can be saved.

For example, the first shell-shaped structural element and/or the second shell-shaped structural elements form part of a skin of an aircraft. However, the shell-shaped structural elements may also consist of structural elements that are arranged farther within the aircraft. In this context, shell-shaped means that the thickness of the structural elements is significantly smaller than their lateral extent. The shell-shaped structural elements particularly may have a plane or curved shape. For example, the shell-shaped structural elements are bent in a first direction, but not bent in a second direction that extends perpendicular to the first direction. The shell-shaped structural elements therefore may represent, for example, a cylindrical segment of a cylinder surface area. Consequently, the shell-shaped structural elements may form part of an essentially cylindrical aircraft fuselage, particularly the fuselage of an airplane.

The first shell-shaped structural element and the second shell-shaped structural element respectively overlap partially with the strap. In this case, the strap may likewise consist of a shell-shaped element, the shape of which is adapted to the shell-shaped structural elements. A curvature of the strap particularly may correspond to a curvature of the first shell-shaped structural element and/or the second shell-shaped structural element. In any case, the first shell-shaped structural element and the second shell-shaped structural element may be respectively connected to the strap in the overlapping region by means of a rivet joint. The first shell-shaped structural element particularly is fastened on the strap in the region of the overlap between the first shell-shaped structural element and the strap by means of a rivet joint. Furthermore, the second shell-shaped structural element is fastened on the strap in the region of the overlap between the second shell-shaped structural element and the strap by means of a rivet joint.

In the region of the overlap, the first shell-shaped structural element comprises an edge that extends on the surface of the strap. In this case, the edge extends along a predefined curve with periodic progression such that an overlapping region between the first shell-shaped structural element and the strap is always provided. This applies analogously to the overlapping region between the second shell-shaped structural element and the strap. The edge of the second shell-shaped structural element particularly also extends along and/or parallel to the predefined curve with periodic progression. In other words, the edge of the first shell-shaped structural element and the edge of the second shell-shaped structural element extend on the surface of the strap, for example, in the form of parallel curves.

In this case, a spacing may be provided between the edges of the shell-shaped structural elements, wherein said spacing defines a joint between the two shell-shaped structural elements. However, it is preferred that no spacing exists between the two shell-shaped structural elements. The joint may therefore also be defined by the direct contact of the shell-shaped structural elements. Both shell-shaped structural elements may therefore end flush with one another, for example, in order to form an aerodynamic contour. For example, the periodic progression is an undulating or zigzag-shaped progression, wherein certain shapes may repeat in certain intervals. Examples of such periodic progressions are described in greater detail below in the description of the figures.

According to an embodiment, the periodic progression of the curve is an undulating progression of the curve.

The edge of the first shell-shaped structural element therefore may extend on the surface of the strap along the predefined curve with undulating progression. Furthermore, the edge of the second shell-shaped structural element may likewise extend on the surface of the strap along and/or parallel to the curve with undulating progression. The undulating progression may be defined, for example, by a mathematical function. For example, the undulating progression is defined by a number of radii that are respectively connected to one another by straight segments. The undulating progression may furthermore be defined by a sine function with a predefined deflection and/or amplitude. However, the undulating progression is preferably defined by segments of a circle with certain radii that are respectively connected to one another by straight segments. In this case, the segments of a circle may respectively have radii, the centers of which lie in or in the region of rivets of the rivet joints.

According to another embodiment, the strap is realized in a shell-shaped fashion and has a curved surface.

For example, the strap may be curved in a first direction and not curved in a second direction that extends perpendicular to the first direction, e.g., similar to a cylindrical segment.

However, it is also possible that the strap is curved in directions extending perpendicular to one another, e.g., similar to a spherical shell. The strap may be connected to the first shell-shaped structural element and the second shell-shaped structural element in an overlapping fashion. One part of the strap particularly is fastened on the first shell-shaped structural element and another part of the strap is fastened on the second shell-shaped structural element. This fastening is respectively realized by means of a rivet joint. The rivet joint may comprise a plurality of rivets.

According to another embodiment, the rivet joint comprises a plurality of rivets that are arranged the surface of the strap in the form of rows that are spaced apart from one another. In this case, the number of rivets in adjacent rows respectively differs by one rivet.

For example, a first row for connecting the first shell-shaped structural element to the strap comprises two rivets and a second row, which is spaced apart from the first row, comprises three rivets. A third row once again comprises only two rivets and a fourth row once again comprises three rivets such that the number of rivets in adjacent rows alternately differs by one rivet. The second shell-shaped structural element is analogously fastened on the strap by means of another rivet joint, wherein this rivet joint likewise comprises several adjacent rows of rivets. The number of rivets in adjacent rows respectively differs by one rivet. It would be possible that one row of rivets, which connect the first shell-shaped structural element to the strap, comprises a corresponding or opposite row of rivets, which connect the second shell-shaped structural element to the strap. These corresponding or opposite rows of rivets may comprise, for example, a total of five rivets. For example, a row for connecting the first shell-such control element to the strap comprises three rivets and an opposite, corresponding row for connecting the second shell-shaped structural element comprises two rivets.

According to another embodiment of the invention, the individual rows of rivets are spaced apart from one another in a lateral direction of the aircraft structure. In this case, the lateral direction is essentially aligned parallel to a direction of the periodic or undulating progression.

The lateral direction describes, for example, a perpendicular or parallel direction relative to a longitudinal axis of an aircraft, in which the aircraft structure is arranged. For example, the direction of the periodic or undulating progression is a center line or zero line, about which or perpendicular to which the predefined curve is periodically deflected. In other words, the progressing direction should be interpreted as an axis, along which the periodic or undulating progression extends. The progressing direction therefore may be a center line, about which the respective deflections of the periodic progression takes place.

The individual rows of rivets may furthermore be spaced apart from one another in a circumferential direction of a circle. This means that a cross section of an aircraft fuselage is essentially circular and the individual rows of rivets are spaced apart from one another in the circumferential direction of the circle. In other words, the first shell-shaped structural element and the second shell-shaped structural elements are parts of fuselage skin segments that are fastened to one another by means of the strap. In this case, the direction of the periodic progression of the curve, along or parallel to which the edge of the first shell-shaped structural element and/or the edge of the second shell-shaped structural element extends, may be aligned, for example, perpendicular to a longitudinal axis of the aircraft fuselage.

The deflections about the progressing direction, i.e. the so-called peak-to-valley values of the periodic progression of the edges of the shell-shaped structural elements to be connected, are preferably chosen such that the rivets lie at least partially on a line extending parallel to the progressing direction on both sides of the joint or the edges, respectively. These rivets may particularly lie on the axis of the progressing direction. In this case, it would furthermore be conceivable that a minimal edge clearance of the rivets from the edges of the shell-shaped structural elements is observed. The rivets lying along the progressing direction particularly may be spaced apart from the respective edge by a minimal distance. This makes it possible, for example, to improve the mechanical properties of the rivet joint.

The direction of the periodic progression may extend parallel to a longitudinal axis of the aircraft or perpendicular to the longitudinal axis of the aircraft. The progressing direction may furthermore be aligned at a predefined angle to the longitudinal axis of the aircraft. The first shell-shaped structural element and the second shell-shaped structural element therefore can have arbitrary geometries that jointly form part of a skin of the aircraft and are connected to one another along different directions.

According to another embodiment, a first edge of the strap extends on a surface of the first shell-shaped structural element with a periodic progression that corresponds to the periodic progression of the predefined curve.

The periodic progression, with which the first edge of the strap extends on the surface of the first shell-shaped structural element, particularly may be a curve extending parallel to the predefined curve with periodic progression, along which the edge of the first shell-shaped structural element extends. For example, the predefined curve with periodic progression, along which the edge of the first shell-shaped structural element extends, may have the same shape as the periodic progression, along which the first edge of the strap extends. The progression of the first edge of the strap therefore may be copied from the progression of the edge of the first shell-shaped structural element and/or the second shell-shaped structural element. The progressions of the edges of the strap and the progressions of the edges of the shell-shaped structural elements may particularly consist of parallel curves.

According to another embodiment, a second edge of the strap extends on a surface of the second shell-shaped structural element with a periodic progression that corresponds to the periodic progression of the predefined curve and/or the periodic progression of the first edge of the strap.

The first edge and the second edge of the strap therefore may represent, in particular, two opposite edges of the strap with identical shapes. The first edge and the second edge of the strap respectively extend on the surface of the first and the second shell-shaped structural element, in particular, in an undulating fashion.

The first edge of the strap and the second edge of the strap may be characterized, for example, by a curve progression that extends parallel to the curve with periodic progression characterizing the edge of the first shell-shaped structural element. The predefined curve with periodic progression, along which the edge of the first shell-shaped structural element and/or the second shell-shaped structural element extends, and the periodic progression of the first and second edge of the strap may particularly consist of parallel curves.

According to another embodiment, the rivet joint comprises a plurality of rivets that are arranged on the surface of the strap in the form of rows that are spaced apart from one another, wherein the individual rows respectively comprise the same number of rivets.

In this case, each individual row may respectively comprise six rivets. However, it is also possible that each individual row respectively comprises four rivets. In any case, the individual rows of rivets may be offset relative to one another in a longitudinal direction. The longitudinal direction may extend perpendicular to the lateral direction and/or perpendicular to the direction of the undulating or periodic progression. For example, the longitudinal direction is aligned parallel to a longitudinal axis of an aircraft, particularly an airplane. The positioning of the rivets in the individual rows of rivets therefore can be adapted to the periodic progression of the predefined curve, along which the edge of the first shell-shaped structural element and/or the edge of the second shell-shaped structural element extends.

According to an aspect, an aircraft with an aircraft structure is proposed. The aircraft may, for example, be an airplane or a helicopter. Several aircraft structures may also be arranged in the aircraft. For example, the aircraft structure is a connection structure for connecting skin segments of the aircraft, wherein the skin segments are formed by the first and second shell-shaped structural elements.

According to an embodiment, the first shell-shaped structural element and the second shell-shaped structural element respectively form part of a skin of the aircraft.

In this case, the shell-shaped skin segments are connected to one another by means of the strap. The strap is connected to the first shell-shaped structural element, i.e. a first skin segment, and to the second shell-shaped structural element, i.e. a second skin segment, in an overlapping fashion by means of a rivet joint. Since the skin of the aircraft typically has a curved shape, the first shell-shaped structural element, which represents part of the skin, and the second shell-shaped structural element, which likewise represents part of the skin of the aircraft, may also be curved. The strap may likewise be curved in at least one direction, for example in a circumferential direction of the aircraft fuselage.

According to an aspect, a method for manufacturing an aircraft structure is proposed. In a first step of the method, a first shell-shaped structural element and a second shell-shaped structural element are made available. A strap is made available in another step. In another step of the method, the first shell-shaped structural element is furthermore arranged such that an edge of the first shell-shaped structural element extends on a surface of the strap along a predefined curve with periodic progression. This progression is formed, for example, by an undulating progression. In another step of the method, the second shell-shaped structural element is arranged such that an edge of the second shell-shaped structural element extends on the surface of the strap along or parallel to the predefined curve with periodic progression. If the edge of the first shell-shaped structural element and the edge of the second shell-shaped structural element touch one another or are in contact with one another, the edge of the first shell-shaped structural element, as well as the edge of the second shell-shaped structural element, could extend along the predefined curve with periodic progression. In another step of the method, the first shell-shaped structural element and the second shell-shaped structural element are respectively fastened on the strap by means of a rivet joint.

A third shell-shaped structural element, which is connected to the second shell-shaped structural element by means of a second strap, may be made available in another step. The fastening of the third shell-shaped structural element on the second shell-shaped structural element with the aid of the second strap may likewise be realized by means of a rivet joint and an overlapping arrangement of the third shell-shaped structural element and the second strap. In this case, an edge of the third shell-shaped structural element may also extend parallel to the predefined curve with periodic progression.

### BRIEF DESCRIPTION OF THE DRAWINGS

The various embodiments will hereinafter be described in conjunction with the following drawing figures, wherein like numerals denote like elements, and:

FIG. 1 shows an aircraft structure according to an exemplary embodiment in an unstressed and in a stressed state.

FIG. 2A shows an aircraft structure according to an exemplary embodiment with a first shell-shaped structural element that is connected to a second shell-shaped structural element by means of a strap.

FIG. 2B shows a sectional view of an aircraft structure according to an exemplary embodiment.

FIG. 2C shows a sectional view of an aircraft structure according to another exemplary embodiment.

FIG. 2D shows an undulating progression of edges of two shell-shaped structural elements according to an exemplary embodiment.

FIG. 2E shows a zigzag-shaped progression of two shell-shaped structural elements according to an exemplary embodiment.

FIG. 2F shows a trapezoidal progression of two shell-shaped structural elements according to an exemplary embodiment.

FIG. 2G shows a construction of a periodic or undulating progression of edges of two shell-shaped structural elements according to an exemplary embodiment.

FIG. 3 shows an aircraft structure according to another exemplary embodiment with a first shell-shaped structural element that is connected to a second shell-shaped structural element by means of a strap.

FIG. 4 shows an aircraft with an aircraft structure according to an exemplary embodiment.

FIG. 5 shows a flowchart for a method for manufacturing an aircraft structure according to an exemplary embodiment of the invention.

### DETAILED DESCRIPTION

The following detailed description is merely exemplary in nature and is not intended to limit the disclosed embodiments or the application and uses thereof. Furthermore, there is no intention to be bound by any theory presented in the preceding background detailed description.

When the same reference symbols are used in different figures in the following description of the figures, these reference symbols identify identical or similar elements. However, identical or similar elements may also be identified by different reference symbols.

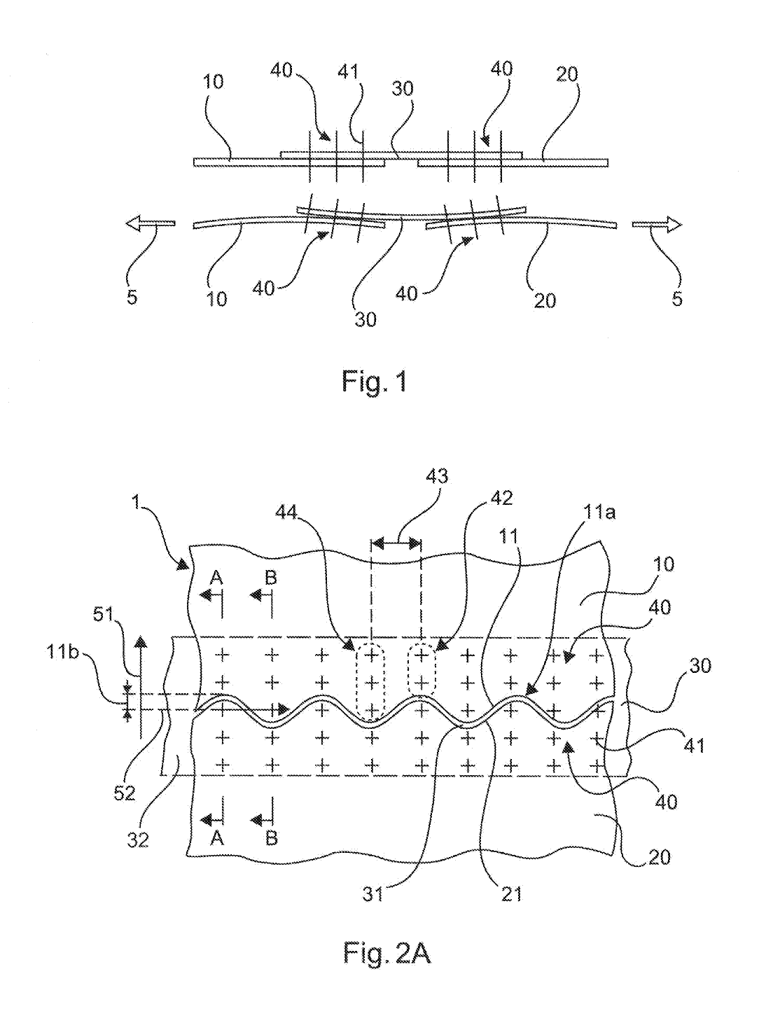

FIG. 1 shows an aircraft structure 1 in an unstressed state and in a stressed state. The upper illustration in FIG. 1 shows the unstressed state of the aircraft structure 1 with a first shell-shaped structural element 10 and a second shell-shaped structural element 20, which is connected to the first shell-shaped structural element 10 with the aid of a strap 30. In this case, the connection is produced by means of a rivet joint 40 between the strap 30 and the respective shell-shaped structural element 10, 20. The rivet joint 40 particularly may comprise a plurality of rivets 41, the positions of which are schematically indicated in the figures. The strap 30 overlaps the first shell-shaped structural element 10 and the second shell-shaped structural element 20 in the region of the respective rivet joint 40.

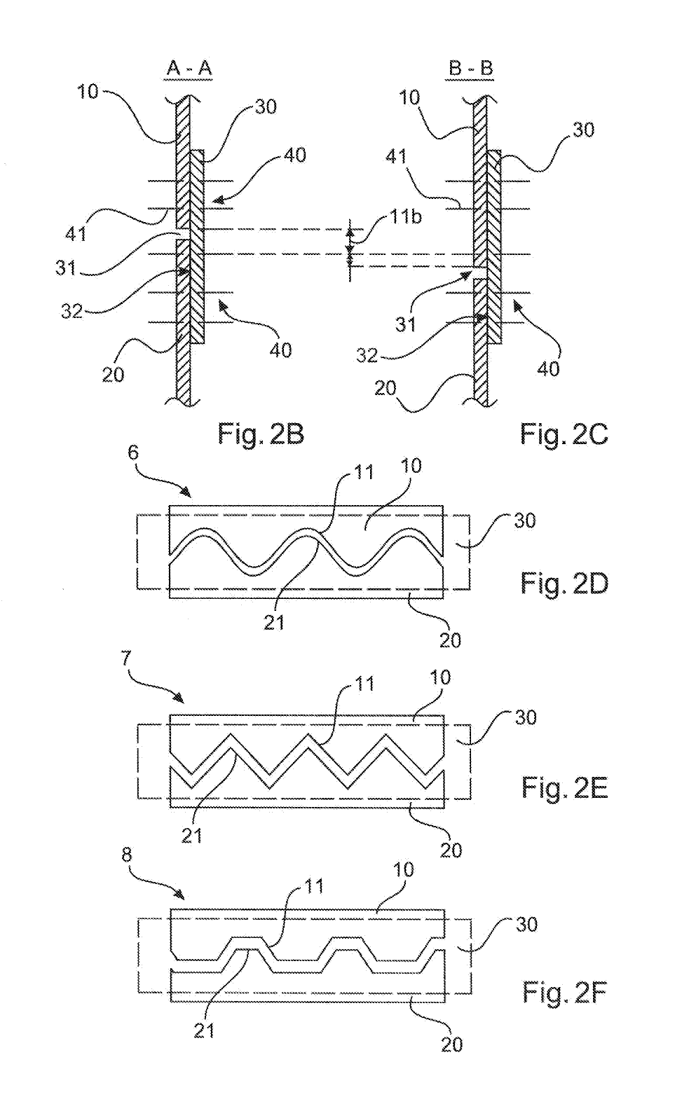

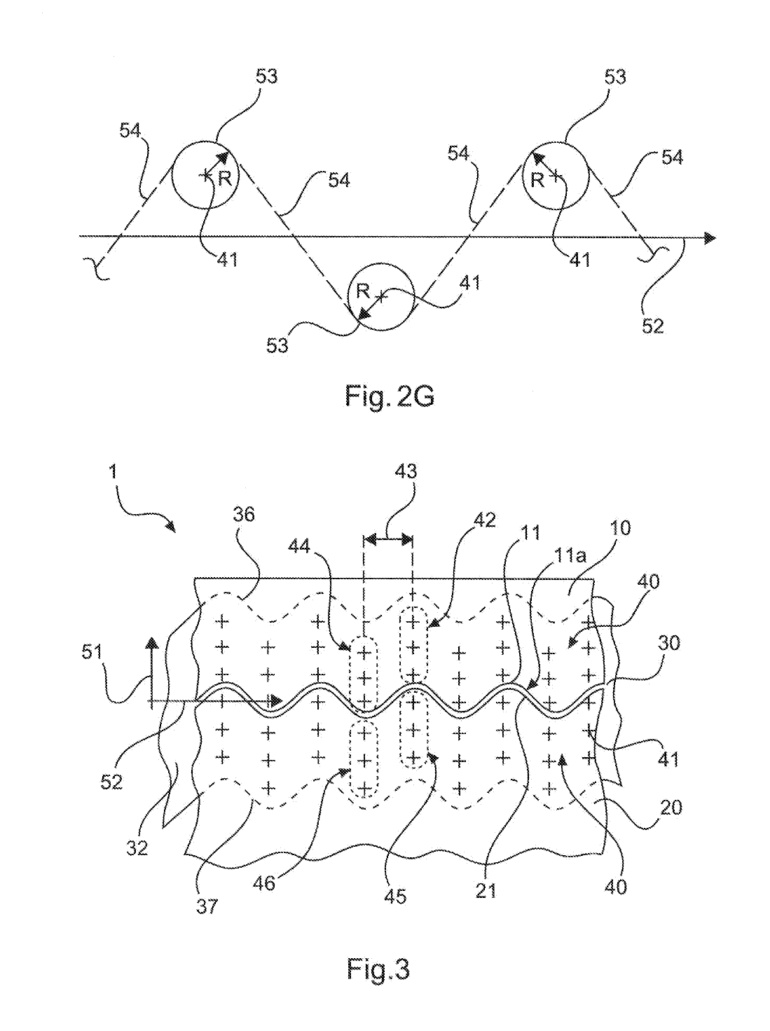

The lower illustration in FIG. 1 shows the aircraft structure 1 in a stressed state. In this case, a tensile force 5 is exerted upon the aircraft structure 1 such that a deflection of the shell-shaped structural elements 10, 20 and of the strap 30 can occur. Such a deflection can be at least suppressed with the aircraft structure 1 illustrated in FIG. 2A. The inventive aircraft structure 1 particularly makes it possible to prevent secondary deflections such that fatigue properties may ultimately also be improved.

FIG. 2A, in particular, shows an aircraft structure 1 with a first shell-shaped structural element 10 and a second shell-shaped structural element 20, wherein the shell-shaped structural elements 10, 20 are respectively connected to or fastened on a strap 30 by means of a rivet joint 40. In this case, the respective rivet joint 40 may comprise a plurality of rivets 41. For example, a first rivet joint 40 connects the first shell-shaped structural element 10 to the strap 30 and a second rivet joint 40 connects the second shell-shaped structural element 20 to the strap 30. An edge 11 of the first shell-shaped structural element 10 extends, for example, on a surface 32 of the strap 30. The edge 11 of the first shell-shaped structural element 10 particularly extends on the surface 32 of the strap 30 along a predefined curve 11a with periodic progression. For example, this predefined curve 11a with periodic progression has an undulating shape. In this case, the periodic progression or the undulating progression extends in a direction 52. For example, the direction 52 of the periodic progression extends parallel to a lateral direction or in itself represents the lateral direction. The lateral direction or the direction of the periodic progression is aligned, for example, perpendicular to a longitudinal axis 51 of an aircraft. For example, an edge 21 of the second shell-shaped structural element 20 likewise has a periodic progression. The edge 21 of the second shell-shaped structural element 20 particularly extends parallel to the curve 11a with periodic progression. In other words, the edge 21 of the second shell-shaped structural element 20 and the edge 11 of the first shell-shaped structural element 10 define parallel curves that follow an undulating progression. The two edges 11, 21 of the two shell-shaped structural elements 10, 20 may have a spacing 31 or offset between one another. For example, this spacing defines the joint between the shell-shaped structural elements 11, 21 to be connected. However, it is preferred that the two edges 11, 21 of the two shell-shaped structural elements 10, 20 end flush with one another and therefore are in contact with one another. For example, the first shell-shaped structural element 10 and the second shell-shaped structural element 20 may form parts of a skin of an aircraft fuselage, particularly an airplane fuselage.

The two shell-shaped structural elements 10, 20 are respectively fastened on the strap 30 by means of rivet joints 40. The rivet joints 40 respectively comprise a plurality of rivets 41. The rivets 41 may be arranged in the form of several rows 42, 44 that are spaced apart from one another. In this case, a first row 42 of rivets 41 and a second row 44 of rivets 41 are separated from one another by a certain spacing 43. In other words, the two rows 42, 44 of rivets 41 are spaced apart from one another. In this case, the number of rivets 41 in adjacent rows of rivets 42, 44 respectively differs by one rivet. According to FIG. 2A, this can be attributed to the undulating progression of the edge 11 of the first shell-shaped structural element 10. The edge 11 of the first shell-shaped structural element 10 with periodic progression particularly extends along the progressing direction 52, wherein the periodic progression has a certain amplitude 11b about the progressing direction 52. The amplitude 11b therefore represents the greatest spacing between the axes of the progressing direction 52 and the edge 11 of the first shell-shaped structural element 10. The number of rivets 41 in adjacent rows may alternate. Analogously, the edge 21 of the second shell-shaped structural element 20 likewise extends along the progressing direction 52. In this case, the rivet joint 40 between the second shell-shaped structural element 20 and the strap 30 also comprises several rows of rivets 1, wherein adjacent rows of rivets 41 respectively comprise a different number of rivets 41. The number of rivets 41 in adjacent rows respectively differs by one rivet 41 in this case. Consequently, the number of rivets 41 in adjacent rows may also alternate.

The deflections about the progressing direction 52, i.e. the so-called peak-to-valley values of the periodic progression of the edges 11, 21 of the shell-shaped structural elements 10, 20 to be connected, are preferably chosen such that the rivets 41 largely lie on a line extending parallel to the progressing direction 52 on both sides of the joint. The rivets 41 may particularly lie on the axis of the progressing direction 52 as illustrated in FIG. 2A. In this case, it would furthermore be conceivable that a minimal edge clearance of the rivets 41 from the edges 11, 21 of the shell-shaped structural elements 10, 20 is observed. The rivets 41 lying along the progressing direction 52 particularly may be spaced apart from the respective edge 11 or 21 by a minimal distance. This makes it possible, in particular, to improve the mechanical properties of the rivet joint 40.

FIG. 2B shows a section A-A through the aircraft structure 1 in FIG. 2A. According to this figure, a row of rivets 41, which connect the first shell-shaped structural element 10 to the strap 30, comprises a smaller number of rivets 41 than in opposite or corresponding row of rivets 41, which connect the second shell-shaped structural element 20 to the strap 30. In FIG. 2B, two rivets 41 are particularly provided for connecting the first shell-shaped structural element 10 to the strap 30, wherein three rivets 41 are provided in the opposite or corresponding row for connecting the second shell-shaped structural element 20 to the strap 30.

FIG. 2C shows another section B-B through the aircraft structure 1, wherein this section extends through an additional adjacent row of rivets. For example, this additional row of rivets is spaced apart from the row of rivets illustrated in the form of a section in FIG. 2B by the spacing 43. This figure particularly shows an offset between the progressions of the respective edges 11, 21 of the two shell-shaped structural elements 10, 20, wherein this offset results from the undulating progression of the respective edge. In this case, the offset is characterized by the amplitude 11b about the zero line or center line of the undulating progression.

It should be noted that a comparison of FIG. 2B and FIG. 2C clearly shows that adjacent rows of rivets 41, which connect the first shell-shaped structural element 10 to the strap, respectively comprise a different number of rivets 41. The number of rivets 41 in adjacent rows respectively differs, in particular, by one rivet. This applies analogously to the respective rows of rivets for connecting the second shell-shaped structural element 20 to the strap 30. However, a total of five rivets 41 are illustrated in the sectional view in FIG. 2B, as well as in the sectional view in FIG. 2C. According to FIG. 2B, two rivets 41 connect the first shell-shaped structural element 10 to the strap 30 and three rivets 41 connect the second shell-shaped structural element 20 to the strap 30. In FIG. 2C that shows the adjacent row of rivets, in contrast, three rivets 41 connect the first shell-shaped structural element 10 to the strap 30 and two rivets 41 connect the second shell-shaped structural element 20 to the strap 30 such that a total of five rivets 41 are respectively provided for connecting the shell-shaped structural elements 10, 20 to the strap 30 in each section through respectively adjacent rows of rivets.

FIG. 2D shows a top view of a periodic or undulating progression 6 and edges 11, 21 of two shell-shaped structural elements 10, 20. In this case, the two shell-shaped structural elements 10, 20 overlap the strap 30 in the region of the respective edges 11, 21.

FIG. 2E shows a zigzag-shaped or trapezoidal progression 7 of two edges 11, 21 of two shell-shaped structural elements 10, 20. In this case, the shell-shaped structural elements 10, 20 overlap the strap 30 in the region of the edges 11, 21. The zigzag-shaped progression therefore also represents a periodic progression.

FIG. 2F shows a trapezoidal progression 8 of two edges 11, 21 of shell-shaped structural elements 10, 20. In this case, the shell-shaped structural elements 10, 20 overlap the strap 30 in the region of the edges 11, 21. The trapezoidal progression 8 of the edges 11, 21 likewise represents a periodic progression.

FIG. 2G shows the construction of a periodic or undulating progression 6 of the edges 11, 21 of the respective shell-shaped structural elements 10, 20. The undulating progression 6 is formed, for example, by segments of a circle 53, as well as straight segments 54. In this case, segments of a circle 53 and straight segments 54 alternate and thereby form an undulating progression along the direction 52. The segments of a circle 53 are respectively characterized by radii R, wherein the center of the radii R is respectively characterized by the center of a rivet 41. However, it is preferred that the rivets 41, i.e. the centers of the radii R, are arranged on the axis of the progressing direction 52. It would furthermore be conceivable that the axis of the progressing direction 52 is arranged between the rivets 41 and the respective radius R. The illustration of the rivets 41 between the progressing direction 52 and the respective radius R in FIG. 2G merely serves for the clarity of the illustration. It should be noted that this merely represents an exemplary construction of a periodic or undulating progression of the edges 11, 21 of the shell-shaped structural elements 10, 20. It would also be possible, in particular, to provide periodic or undulating progressions of the edges 11, 21 that are defined by a sine function.

FIG. 3 shows an aircraft structure 1 with a first shell-shaped structural element 10 and a second shell-shaped structural element 20, wherein the two shell-shaped structural elements 10, 20 are connected to one another by means of a strap 30. The connection between the two shell-shaped structural elements 10, 20 is respectively produced by means of a rivet joint 40 in this case. Each of the rivet joints 40 comprises a plurality of rivets 41, wherein the rivets 41 are arranged in the form of several rows that are spaced apart from one another. In this case, adjacent rows of a rivet joint 40 respectively comprise the same number of rivets 41. A first row 42 of rivets 41, which connects the first shell-shaped structural element 10 to the strap 30, particularly comprises the same number of rivets 41 as an adjacent row 44, which likewise connects the first shell-shaped structural element 10 to the strap 30. The two rows 42, 44 of rivets 41 are separated from one another by the spacing 43 in this case. The two rows 42, 44 furthermore comprise opposite or corresponding rows 45, 46 of rivets 41, which connect the second shell-shaped structural element 20 to the strap 30. The opposite or corresponding rows 45, 46 of rivets 41 are also separated from one another by the spacing 43. Furthermore, the opposite rows 45, 46 respectively also comprise the same number of rivets 41. This can be attributed, in particular, to the periodic progression of the first edge 36 and the second edge 37 of the strap 30. The first edge 36 and the second edge 37 of the strap 30 respectively extend, in particular, parallel to the edges 11, 21 of the first shell-shaped structural element 10 and the second shell-shaped structural element 20. Consequently, the first edge 36 and the second edge 37 respectively represent curves that extend parallel to the edges 11, 21 of the two shell-shaped structural elements 10, 20. Three rivets 41 are preferably provided per row for each rivet joint 40. In other words, the first shell-shaped structural element 10 is connected to the strap 30 by rows of rivets 42, 44, wherein the rows of rivets 42, 44 respectively comprise three rivets 41. The second shell-shaped structural element 20 is furthermore connected to the strap 30 by rows of rivets 45, 46, wherein each of the rows of rivets 45, 46 respectively comprises three rivets 41.

It should be noted that the undulating progression 11a of the edge 11, as well as of the edge 21 and the first edge 36 and the second edge 37 of the strap 30, extends in the progressing direction 52. The deflections or amplitudes of the periodic progression or the undulating progression of the respective curves or edges are aligned in the longitudinal direction 51 in this case.

The deflections about the progressing direction 52, i.e. the so-called peak-to-valley values of the periodic progression of the edges 11, 21 of the shell-shaped structural elements 10, 20 to be connected, are preferably chosen such that the rivets 41 largely lie on a line extending parallel to the progressing direction 52 on both sides of the joint. The rivets 41 may particularly lie on the axis of the progressing direction 52 as illustrated in FIG. 3, but also in FIG. 2A. In this case, it would furthermore be conceivable that a minimal edge clearance of the rivets 41 from the edges 11, 21 of the shell-shaped structural elements 10, 20 is observed. The rivets 41 lying along the progressing direction 52 particularly may be spaced apart from the respective edge 11 or 21 by a minimal distance.

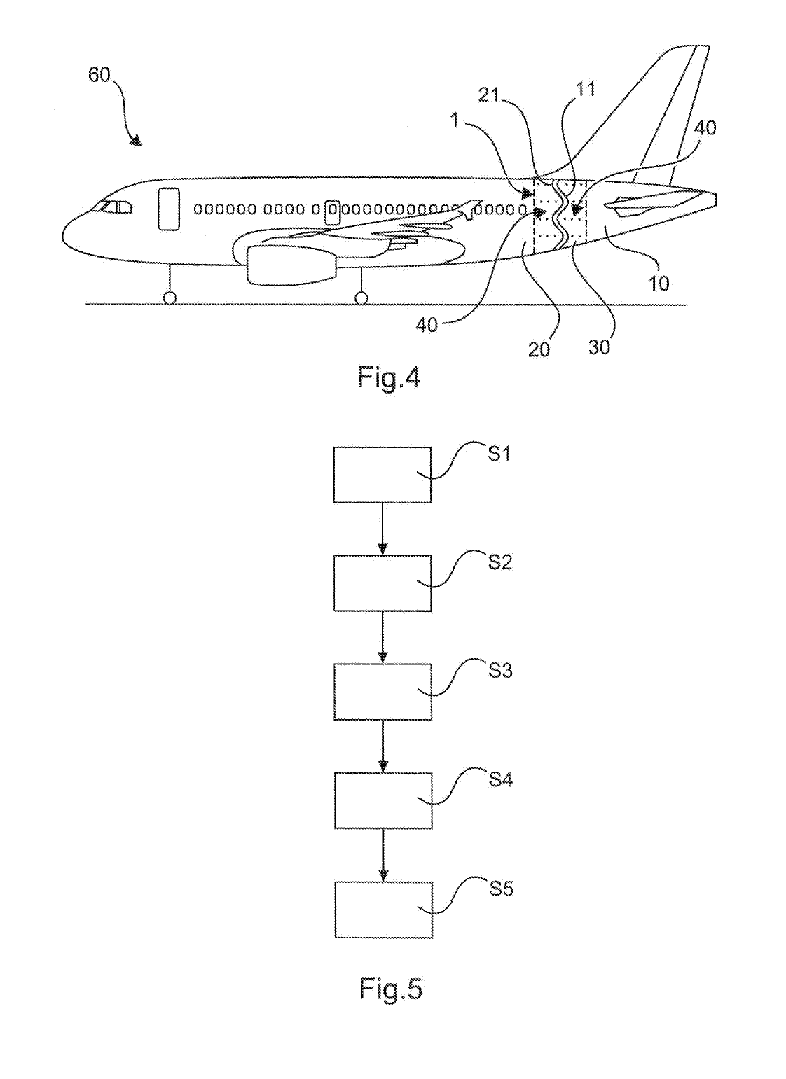

FIG. 4 shows an aircraft 60 with an aircraft structure 1. For example, the aircraft structure 1 comprises a first shell-shaped structural element 10 and a second shell-shaped structural element 20 that respectively represent part of a skin of the aircraft 60. The aircraft 60 consists, for example, of an airplane. A strap 30 flatly overlaps the first shell-shaped structural element 10, as well as the second shell-shaped structural element 20. For example, an edge 11 of the first shell-shaped structural element 10 and an edge 21 of the second shell-shaped structural element 20 have an undulating shape. The direction 52 of the undulating shape or the undulating progression extends, for example, in a circumferential direction around the aircraft fuselage as illustrated in FIG. 4. The strap 30 is connected to the respective shell-shaped structural elements 10, 20, i.e. to the respective parts of the skin of the aircraft 60, by means of a rivet joint 40. The two shell-shaped structural elements 10, 20 are particularly fastened on the strap 30 with several rivets 41 of the rivet joint 40.

It would also be conceivable that the undulating progression, i.e. the direction 52 of the undulating progression, also extends perpendicular to a longitudinal axis of the aircraft 60 or at a predefined angle to the longitudinal axis of the aircraft 60. In other words, the undulating progression may essentially also extend perpendicular to the circumferential direction of the aircraft fuselage. Shell-shaped structural components 10, 20 with different geometries can therefore be assembled.

FIG. 5 shows a flowchart for a method for manufacturing an aircraft structure 1. In a step S1 of the method, a first shell-shaped structural element 10 and a second shell-shaped structural element 20 are made available. A strap 30 is made available in a step S2 of the method. In another step S3 of the method, the first shell-shaped structural element 10 is furthermore arranged such that an edge 11 of the first shell-shaped structural element 10 extends on a surface 32 of the strap 30 along a predefined curve 11a with periodic progression. In another step S4 of the method, the second shell-shaped structural element 20 is arranged such that an edge 21 of the second shell-shaped structural element extends on the surface 32 of the strap 30 parallel to the predefined curve 11a with periodic progression. The first shell-shaped structural element 10 and the second shell-shaped structural element 20 are respectively fastened on the strap 30 by means of a rivet joint 40 in another step S5 of the method.

As a supplement, it should be noted that “comprising” does not exclude any other elements or steps, and that “a” or “an” does not exclude a plurality. It should furthermore be noted that characteristics or steps that were described with reference to one of the above exemplary embodiments can also be used in combination with other characteristics or steps of other above-described exemplary embodiments. Reference symbols in the claims should not be interpreted in a restrictive sense.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the embodiment in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the embodiment as set forth in the appended claims and their legal equivalents.

1. An aircraft structure, comprising:
a first shell-shaped structural element and a second shell-shaped structural element;
a strap;
wherein the first shell-shaped structural element and the second shell-shaped structural element are respectively fastened on the strap by means of a rivet joint;
wherein an edge of the first shell-shaped structural element extends on a surface of the strap along a predefined curve with periodic progression; and
wherein an edge of the second shell-shaped structural element extends on the surface of the strap parallel to the curve with periodic progression.

2. The aircraft structure of claim 1,
wherein the periodic progression is an undulating progression.

3. The aircraft structure of claim 1,
wherein the strap is realized in a shell-shaped fashion and comprises a curved surface.

4. The aircraft structure of claim 1,
wherein the rivet joint comprises a plurality of rivets that are arranged on the surface of the strap in the form of rows that are spaced apart from one another; and
wherein the number of rivets in adjacent rows respectively differs by one rivet.

5. The aircraft structure of claim 4,
wherein the individual rows of rivets are spaced apart from one another in a lateral direction of the aircraft structure, and
wherein the lateral direction is substantially aligned parallel to a direction of the periodic progression.

6. The aircraft structure of claim 1,
wherein a first edge of the scrap extends on a surface of the first shell-shaped structural element with a periodic progression that corresponds to the periodic progression of the predefined curve.

7. The aircraft structure of claim 1,
wherein a second edge of the strap extends on a surface of the second shell-shaped structural element with a periodic progression that corresponds to the periodic progression of the predefined curve.

8. The aircraft structure of claim 6,
wherein the rivet joint comprises a plurality of rivets that are arranged on the surface of the strap in the form of rows that are spaced apart from one another; and
wherein the individual rows respectively comprise the same number of rivets.

9. (canceled)

10. (canceled)

11. A method for manufacturing an aircraft structure, comprising the steps of:
making available a first shell-shaped structural element and a second shell-shaped structural element;
making available a strap;
arranging the first shell-shaped structural element such that an edge of the first shell-shaped structural element extends on a surface of the strap along a predefined curve with periodic progression;
arranging the second shell-shaped structural element such that an edge of the second shell-shaped structural element extends on the surface of the strap parallel to the predefined curve with periodic progression; and
respectively fastening the first shell-shaped structural element and the second shell-shaped structural element on the strap by means of a rivet joint.

12. An aircraft, comprising:
a first shell-shaped structural element and a second shell-shaped structural element;
a strap;
wherein the first shell-shaped structural element and the second shell-shaped structural element are respectively fastened on the strap by means of a rivet joint;
wherein an edge of the first shell-shaped structural element extends on a surface of the strap along a predefined curve with periodic progression; and
wherein an edge of the second shell-shaped structural element extends on the surface of the strap parallel to the curve with periodic progression; and
wherein the first shell-shaped structural element and the second shell-shaped structural element respectively form part of a shell of the aircraft.

13. The aircraft structure of claim 12,
wherein the periodic progression is an undulating progression;
wherein the strap is realized in a shell-shaped fashion and comprises a curved surface,
wherein the lateral direction is substantially aligned parallel to a direction of the periodic progression; and
wherein a first edge of the strap extends on a surface of the first shell-shaped structural element with a periodic progression that corresponds to the periodic progression of the predefined curve.

14. The aircraft structure of claim 13,
wherein a second edge of the strap extends on a surface of the second shell-shaped structural element with a periodic progression that corresponds to the periodic progression of the predefined curve; and
wherein the rivet joint comprises a plurality of rivets that are arranged on the surface of the strap in the form of rows that are spaced apart from one another; and
wherein the individual rows respectively comprise the same number of rivets.
